(19) United States
(12) Patent Application Publication
(10) Pub. No.: US 2026/0228555 A1
(43) Pub. Date: Aug. 6, 2026

(54) METHODS AND SYSTEMS FOR DISTANCE BASED SEQUENCING IN CONTINUAL LEARNING

(71) Applicant: HUAWEI TECHNOLOGIES CO., LTD., Shenzhen (CN)

(72) Inventor: Hesham Gamal Aly Mohammed MOUSSA, Ottawa (CA)

(21) Appl. No.: 19/043,058

(22) Filed: Jan. 31, 2025

(51) Int. Cl. G06N 3/096

(52) U.S. Cl. CPC G06N 3/096

(57) ABSTRACT

Method and systems for training an AI model on datasets from a plurality of nodes connected to form a knowledge sharing network. The method comprises identifying a first host node in the knowledge sharing network that is currently hosting the AI model to train the model according to a first data set associated with the first host node; determining a comparative distance measure between the first dataset associated with the first host node and each dataset associated with each node in the knowledge sharing network; identifying the next host node in the knowledge sharing network based on a decision rule that evaluates the comparative distance measures from each of the nodes available for hosting; moving the AI model trained on the first host node towards the identified next host node to continue training the AI model according to a dataset associated with the identified next host node.

### FIELD

The present technology relates generally to machine learning and more specifically to methods and systems for distance-based sequencing in continual learning scenarios.

### BACKGROUND

Machine learning models are known to exhibit or surpass human level performance on individual tasks, such as object recognition and the like. While these results are impressive, they are generally obtained with static models which are incapable of adapting their behavior over time. As a result, a model is only good for the data it was trained on. This means the training process must be restarted each time new data becomes available. This manner of operating becomes intractable in a dynamic environment where new data is constantly being generated. Accordingly, systems that adapt continually and keep on learning over time have given rise to the AI field of continual learning.

Continual Learning studies the problem of learning from an infinite stream of data, with the goal of gradually extending acquired knowledge and using it for future learning no matter how diverse the data is. One of the major challenges in continual learning paradigm is to learn without catastrophic forgetting (i.e., performance on a previously learned dataset or domain should not significantly degrade over time as new tasks or domains are added.)

Continual learning comprises two modes of operation which are referred to as centralized and decentralized. The former is stationary, and new tasks are brought to it sequentially (“data moves towards the model”) and the latter comprises tasks distributed across many nodes and the model moves from one node to the next to learn the different tasks sequentially (“model moves to the data location)”.

Catastrophic forgetting occurs where an artificial neural network (NN), and/or other Artificial Intelligence architectures, that accumulated knowledge from a previously learnt task(s) (e.g. task A) abruptly loses that learnt knowledge as it attempts to accumulate new knowledge relevant to a new task (e.g. task B) that is currently being learned. This phenomenon may occur when the network is trained sequentially on multiple tasks as weights that are important for task A in the network are not the same as those for task B. For example, initially, losses in the model improves for task A as it trains on task A, but performs poorly on task B. Once the model stops training on task A and starts to train on task B, the model “forgets” what it learned about task A while its performance on task B improves. This is referred to as the catastrophic forgetting phenomenon.

One solution to catastrophic forgetting is to train the model in a centralized manner where all the data from all the tasks are placed in a single location, mixed together, and presented to the model as one global dataset. The advantage in this method is that the model finds the solution that best suits all the data. However, the centralization method is costly and is often not feasible. Gathering data in a centralized location might lead the model to a breach in data privacy as data nodes must share their data with a centralized entity. Further as new tasks occur, these must be added to the overall data set. The model then requires complete re-training on the full updated dataset which is a highly intensive computational process. Additionally, centralization presents a single point of failure: if the training is aborted before convergence due to hardware failure, complete re-training may be required. This can be compared to sequential learning, by which the model weights are stored after each task learned. Thus, if a failure occurs, re-training the latest version of the model on the current task is performed to recover the pre-failure model in a sequential learning process.

Various suboptimal alternative methods/solutions have been proposed to address the catastrophic forgetting phenomenon. In a decentralized setting, these methods include:
Replay Methods in which samples from previous tasks are either stored or generated (pseudo samples) with generative models and are used as inputs with the next tasks or to constrain the weight optimization as new tasks come in;
Regularization-based methods in which an extra regularization term is introduced in the loss function, consolidating previous knowledge when learning on new data; and
Parameter isolation methods in which different model parameters are dedicated to each task, thereby preventing any possible forgetting. If model architecture size is not constrained, one can grow new branches for new tasks, while freezing previous task parameters, or dedicate a model copy to each task.

In general, the three methods above are directed to ways to limit the change in model weights as the model moves between tasks. A disadvantage of this approach is the fact that the performance depends on the order of tasks being presented to the model.

Some methods/solutions are directed to ordering of tasks as a factor that impacts catastrophic forgetting and presents a method to choose the order given an initial model and different tasks.

Some methods propose a distance measure being used in the field of Neural Architecture search (NAS) where it is used to choose a neural architecture that best suits a given task.

However, to date none of the proposals really solves the catastrophic forgetting phenomenon, particularly in decentralized learning.

Accordingly, the present disclosure is seeking to overcome at least some of the deficiencies of the above methods/solutions in seeking to overcome the catastrophic forgetting phenomenon.

### SUMMARY

In a first aspect, a method is provided of training a model on datasets from a plurality of nodes in a network. In some embodiments, the method is performed by one or more computer processors executing software instructions. The method comprises: identifying a first host node in the network that is currently hosting the model to train the model according to a first data set associated with the first node; determining a comparative distance measure from each node in the network that is available for hosting training to becoming a next host node; and identifying the next host node in the network based on a decision rule that evaluates the comparative distance measure from each node.

In some embodiments, the comparative distance measure comprises a Fisher distance.

In some embodiments, the method further comprises sending a trigger for available nodes to indicate a state to be considered as the next host node.

In some embodiments, the method further comprises requesting each available node configured to provide a Fisher distance based on a Fisher information matrix (FIM).

In some embodiments, the Fisher distance is calculated based on the following equation:

$${D}_{{θ}^{t}} = {\{ {d}_{{θ}^{t}} [ i , j ] \}}_{i \neq j} , ∀ j ∈ ( 1 , 2 , … , N )$$

where: D_{θ}_{^{t}} is a vector containing a set of fisher distances between the i^{th} dataset and the j^{th} dataset with respect to model weights at time t given by θ^{t} θ^{t} corresponds to the model weights after training on the dataset associated with the current host node.

In some embodiments, the decision rule is based on the Fisher Distance.

In some embodiments, the decision rule is based on comparing the Fisher Distance with a target value indicative of a model parameter.

In some embodiments, the decision rule selects as the next node a node with a furthest distance from the first host node.

In some embodiments, the decision rule selects as the next node a node with a closest distance to the first host node.

In some embodiment, the method comprises one of the plurality of nodes acting as a computing surrogate node for another one of the plurality of nodes, the computing surrogate node receiving a minibatch of data from the dataset of the another node and determining the comparative distance measure on behalf of the another node using the model based on the minibatch.

In some embodiments, the method comprises a central sequencer receiving the model from the host node and a minibatch of data from the dataset of each of the plurality of nodes and determining the comparative distance measure for each of the nodes using the model based on the minibatch.

In some embodiments, the method comprises a central sequencer receiving the comparative distance measure determined at each of the nodes, the central sequencer identifying the next host node based on the received comparative distance measures.

In some embodiments, the comparative distance measure is determined using the model and a minibatch or sample of the dataset of each of the nodes.

In some embodiments, the comparative distance measure represents a distance in parameter space between the model as trained by the dataset of the host node and the model as trained by a sample of the dataset of each of the plurality of nodes.

In some embodiments, the network is at least one of decentralized, centralized, fully connected and hierarchical.

In some embodiments, the model comprises a neural network. In some embodiments, the model could be and/or comprises any other AI model architecture (e.g., transformers etc.).

In some embodiments, the network comprises multiple networks each comprising one or more nodes representing a dataset and training task for training the model.

In another aspect, a system is provided that comprises a memory, at least one processor and computer program instructions stored on the memory. The computer program instructions are executable by the at least one processor such that a model to be trained by a network comprising a plurality of nodes and the at least one processor are configured to: identify a first host node in the network that is currently hosting a model to train the model according to a first data set associated with the first node; determine a comparative distance measure from each node in the network that is available for hosting training to becoming a next host node; identify the next host node in the network based on a decision rule to determine which of the available nodes is a match to a target value of the comparative distance measure.

In some embodiments, the comparative distance measure comprises a Fisher distance.

In some embodiments, the at least one processor is configured to send a trigger for available nodes to indicate a state to be considered as the next host node.

In some embodiments, the at least one processor is configured to further request each available node configured to provide a Fisher distance based on a Fisher information matrix (FIM).

In some embodiments, the Fisher distance is calculated based on equation 2 below.

In some embodiments, the decision rule is based on the Fisher Distance.

In some embodiments, the decision rule is based on comparing the Fisher Distance with a target value indicative of a model parameter.

In some embodiments, the decision rule selects as the next node a node a furthest distance from the first host node.

In some embodiments, the decision rule selects as the next node a node with a closest distance to the first host node.

In some embodiments, the model is a neural network.

In some embodiments, the network is decentralized, centralized, fully connected, hierarchical or combinations thereof.

In some embodiments, the network comprises more than one network.

In some embodiments, the network comprises multiple networks each comprising one or more nodes to be trained.

In some embodiments, the network comprises multiple networks, each of the multiple networks comprising a cluster of nodes, wherein the comparative distance measure is communicated from a designated head node of each of the clusters of nodes without communicating the datasets or a part thereof between the clusters of nodes.

In some embodiments, the model is trained at each of the plurality of nodes using the dataset of the respective node and a loss function.

In another aspect, a method is provided of training an artificial intelligence (AI) model on datasets from a plurality of nodes connected to form a knowledge sharing network. In some embodiments, the method is performed by one or more computer processors executing software instructions. The method comprises: identifying a first host node in the knowledge sharing network that is currently hosting the AI model to train the model according to a first data set associated with the first host node; determining a comparative distance measure between the first dataset associated with the first host node and each dataset associated with each node in the knowledge sharing network that is available for hosting and continue training the AI model to becoming a next host node; identifying the next host node in the knowledge sharing network based on a decision rule that evaluates the comparative distance measures from each of the nodes available for hosting; moving the AI model trained on the first host node towards the identified next host node to continue training the AI model according to a dataset associated with the identified next host node; and stopping the next host node identification based on a set of predefined stoppage criteria.

In some embodiments, the stoppage criteria comprises at least one of a training target performance metric being achieved and the nodes available for hosting being exhausted.

In another aspect, a computer program product is provided comprising instructions which, when the program is executed by a computer, cause the computer to carry out the steps of: identifying a first host node in a network that is currently hosting a model to train the model according to a first data set associated with the first node; determining a comparative distance measure from each node in the network that is available for hosting training to becoming a next host node; and identifying the next host node in the network based on a decision rule that evaluates the comparative distance measures. In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, a knowledge sharing network (e.g., in machine sense) refers to a group of nodes (e.g., computers or electronic devices etc.) that are capable or participating in a collective process of training an AI model. By training AI models collectively and/or jointly, this constitutes a knowledge sharing setting from a machine learning point of view. Additionally, the assumption is that these nodes are able to communicate together forming a network like structure where knowledge is shared. The communication can happen in various forms and using different media. For instance, nodes could communicate together in a wireless or wired fashion. They may use a communication technology such as 5G, or previous or future generation of communication technology or WIFI or a combination of thereof.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 illustrates a graphical representation of a first example implementation of determining next nodes, in accordance with an aspect of the present technology.

FIG. 3 illustrates an example set of steps for implementing a method executed by a processor of the computing device of FIG. 1 for continual learning, in accordance with an aspect of the present technology.

FIG. 4 illustrates an example set of certain steps from FIG. 3 in greater detail, in accordance with an aspect of the present technology.

FIG. 5 illustrates a graphical representation of a second example implementation of determining next nodes, in accordance with an aspect of the present technology.

FIG. 6 illustrates a graphical representation of a third example implementation of determining next nodes, in accordance with an aspect of the present technology.

FIG. 7 illustrates an artificial neural network (ANN) of the model shown in a block of FIG. 3, in accordance with an aspect of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As a person skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the FIG.s, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or customized, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

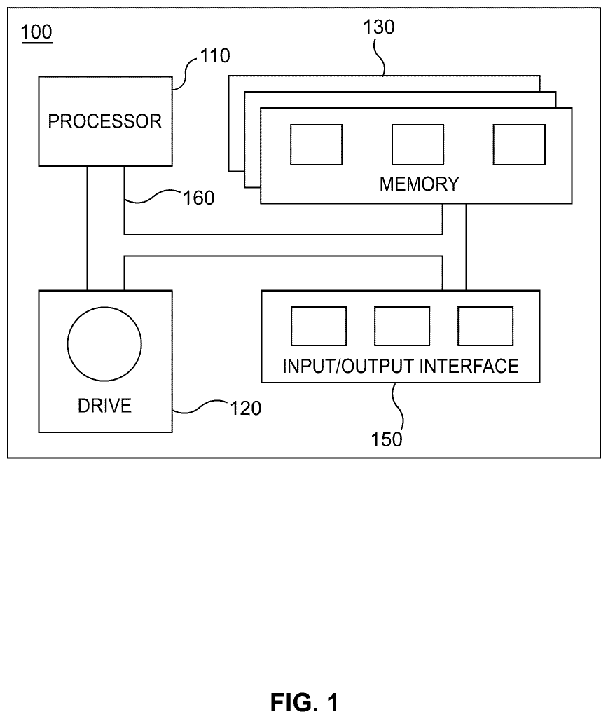

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, an optional solid-state drive 120, a memory 130, such as a random-access memory and one or more input/output interfaces 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fiber Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random-access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (Saas). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

Aspects of the present technology relates to a system, method and associated media where data divided into tasks to be learned in a continual fashion, is distributed among a number of data nodes. A model is provided to learn the data where the model is allowed to move from one data node to the next and locally train on each data node's data. Systems and methods are described herein where a fisher-based distancing algorithm (e.g., comparative distance measure) is used to choose the sequence by which the model can visit the nodes such that the impact of catastrophic forgetting can be minimized. The present technology further seeks to provide a manner in which a next node is chosen in the sequence to reduce the impact of catastrophic forgetting in continual learning. The model is suggested to a system to learn data where the model is permitted to move from one data node to the next node and train locally at that node.

Fisher distance is a measure of dissimilarity or divergence between different probability distribution functions and approximating the distance between respective distribution functions. Other divergent methodologies may also be relevant to the present technology. A parameter is shared among the nodes to be able to compute the Fisher distance and determine a node sequence to be followed for the model to continually learn.

Some embodiments of the present technology combines a multi-task approach and proposes a modified version of the Fisher-based distancing algorithm to choose the best next task or node in a continual training setting. The multi-task approach is based on a model that was trained on Task Tₐ and N={Tₙ} subsequent tasks to choose from where Tₐ∉N. The objective being to find a distance measure that may aid in choosing the best next task that maximizes knowledge transfer. This is achieved by training the model on Tₐ and then computing a Fisher Distance (D) for all possible next tasks with respect to Mₐ:

$${d}_{{M}_{a}} [ a , n ] = {[ \frac{1}{2} * T r ( {F}_{a , n}^{a} + {F}_{a , a}^{a} - 2 * {( {F}_{a , n}^{a} * {F}_{a , a}^{a} )}^{\frac{1}{2}} ) ]}^{\frac{1}{2}} ∀ n \neq a \qquad Equation 1$$

where, Mₐ is the resultant trained model after it was trained on Task Tₐ d_{Ma} refers to the Fisher distance between dataset a (or Task Tₐ) and dataset n (or Task Tₙ). The distance is with respect to the weights of the model trained on dataset a (or Task Tₐ) Mₐ.

$${F}_{a , n}^{a}$$

is a fisher information matrix computed based on model weights trained on dataset a (or Task Tₐ) and data sample collected from dataset n (or Task Tₙ).

$${F}_{a , a}^{a}$$

is the self Fisher information matrix computed based on model weights trained on dataset a (or Task Tₐ) and data sample collected from dataset a (or Task Tₐ). Tr is the trace of the matrix.

To compute the Fisher distance, each node passes a sample of its data through the model and the Fisher information matrix (FIM) is calculated. FIM can be computed in numerous different ways depending on the parameter space matrix representation and vector representation methods. However, for the Fisher Distance formula of equation 1 to be accurate, the same FIM method should be used to compute all the elements thereof.

For completeness, as used in the present specification: Fisher Information: is a way of measuring the amount of information that an observable random variable X carries about an unknown parameter θ upon which the probability of X depends; and Fisher Distance: is a task metric that is easy and efficient to compute, and represents the complexity of transferring the knowledge of one task to another. The Fisher distance may also be referred to herein more broadly as a comparative distance measure.

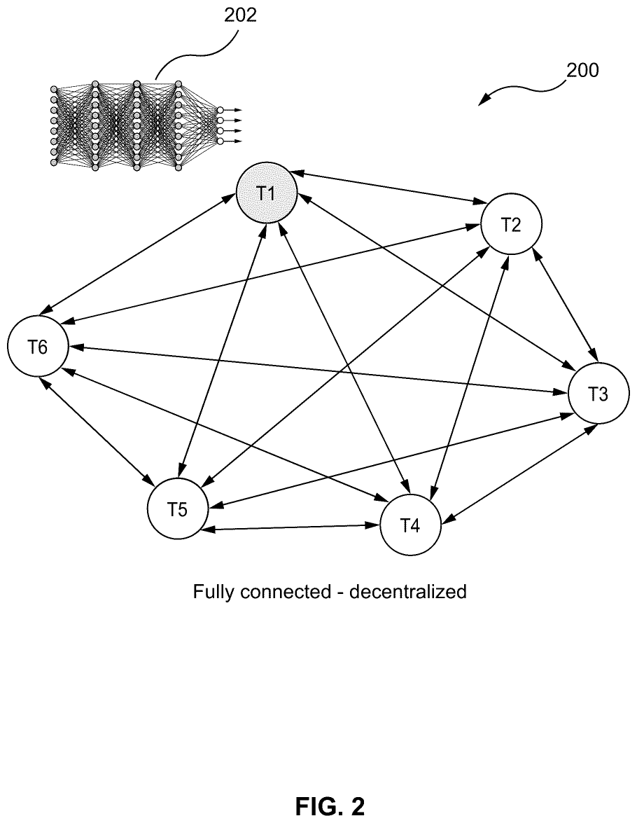

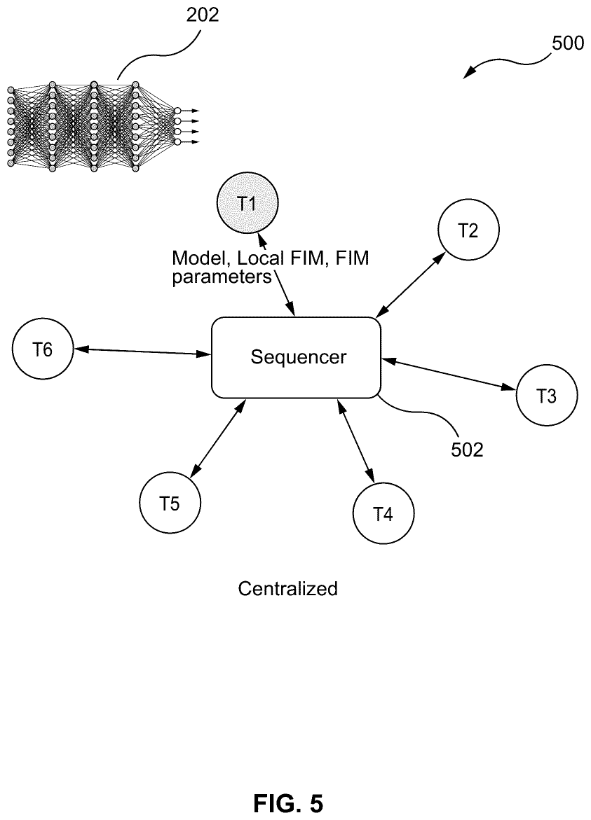

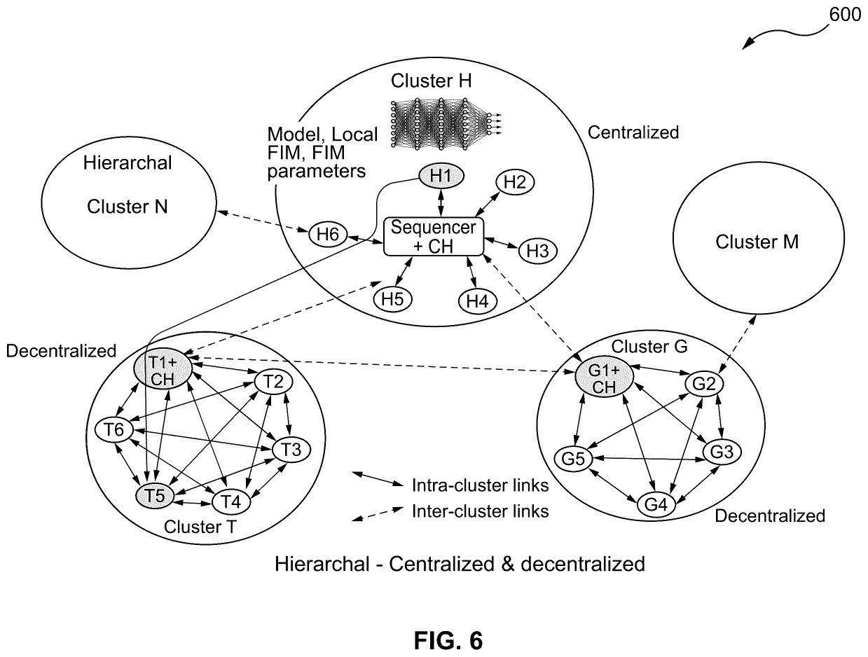

FIG. 2 shows an example embodiment including a fully connected decentralised network 200 comprising multiple nodes T1, T2, T3, T4, T5 and T6 each representing a task or other function in the network 200 such as carrying a data set or any other function for example a function of continual learning in a neural network model 202 in whole or in part with other nodes. The representation of the six nodes in FIG. 2 is by way of example and may alternatively include another number of nodes and any different type of node. The nodes may be the same as one another or one or more of the nodes could be different from the others in terms of function. The connections between the nodes could be formed in any manner as required by use. One of the nodes included in the multiple nodes may comprise a sequencer as shown in greater detail in FIGS. 5 and 6.

It should also be noted that the participation of a node has multiple forms. A node may participate by providing computation only. For instance, a node could be a processor or a cloud computer that does not contain any information but is only capable of executing a computer program such as an AI model training script. It is also contemplated that nodes may also participate with training data only, meaning, they might not have on board compute capability to train an AI model. In some embodiments, the nodes may have storage to store data or a model, but they cannot locally train an AI model. Nodes may also participate by providing data as well as compute. These nodes interact together to train an AI model collectively where each node may rely on the other to cover a shortage. For instance, a compute only node may lend its compute capability to a storage only node. In such a setting, the storage only node may send its stored data to the compute only node where the model would be waiting to start the training.

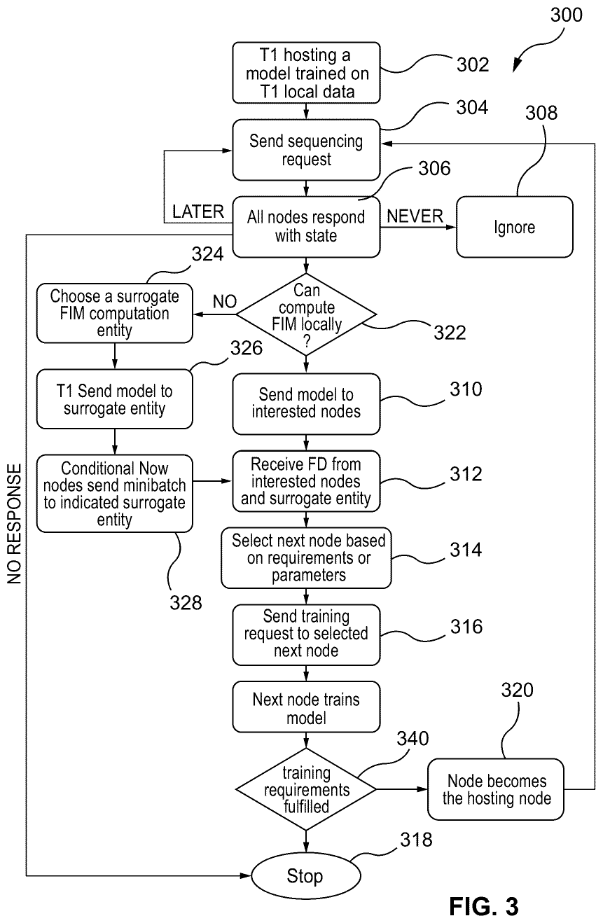

In the network of FIG. 2, the following method 300 in FIG. 3 is carried out in a first node T1 of the nodes T1, T2, T3, T4, T5 and T6. T1 is currently hosting the model and configured to train the model based on a first set of predefined criteria 302. The first node then triggers a sequencing request 304 which comprises a signal indicative of the requirement to find a next training hop from neighboring nodes of the multiple nodes.

Nodes in the network that are nodes of interest respond and indicate the requirement to train the model by generation of a state which is received at the first node 306. The state may include an indicator such as for example: participate now; participate later, participate never, participate now conditionally. The states may be represented numerically, logically or in any other way.

If the state is participate later, the node is reconsidered in a next send sequencing request when and if that occurs LATER. If the state is participate never the node is ignored 308 for the remainder of the training process NEVER. If the response is participate now, the method continues NOW.

If the response is participate NOW CONDITIONALLY, the method continues NOW while considering the Conditions set forth by the relative node.

The copy of the model is sent to nodes showing interest 310 as well as instructions to run the Fisher distancing algorithm according to equation 1 according to a Fisher information value (F_{a,a}^{a}) for the data of the node in question. Each individual node computes the local Fisher302 Distance (D) and sends the result to be received by the first node 312. A copy of the model is kept for later use if required.

In some embodiments, and as an example of a node responding with participate NOW CONDITIONALLY, where the condition is the lack of capacity to compute the FIM locally, if any one or some of the nodes do not have the capacity to compute the FIM locally, those nodes may send an indication of their interest along with another indication stating that they are unable to locally compute the FIM. In such cases, the interested but incapable node determines that the FIM cannot be computed locally at 322 and another node is selected at 324 to act as a computation surrogate. This selection may be made by the hosting node or by the local node that is unable to perform the FIM computation locally. For those nodes, they would be required to send a small sample of their data (a minibatch) at step 328 to the selected node or entity that is able to compute the FIM on their behalf. The model hosting node T1 sends the model, at step 326, to the surrogate FIM computation entity that has been selected. For instance, node T5 indicates to node T1 (one currently hosting the model) that it is interested in participating in the training but cannot compute the FIM locally. T1 may respond to node T5 requesting a sample data (a minibatch) that T1 may use to compute node T5's FIM on its behalf. Node T5 would then prepare the minibatch of data and send it to node T1 for computation. T1 could also ask other nodes who would be willing to compute the FIM on behalf of node T5 or any other entity there is capable of computing the FIM. To that entity, T5 would send the minibatch at 328, and T1 would send the model and FIM parameters at 326.

The first host node selects on the next node based on the Fisher Distances or a target value of the comparative distance measure 314 and sends a training request trigger 316 to the selected other node so that the selected other node (the next node) can run the next stage of the overall training of the model of the multiple data sets. When there are no more available candidates for training the dataset, the process stops 318. An indication of completion of training is sent by the last node to the node hosting the model once there are no more nodes to run the training set.

If there are still nodes listed as interested, the next node is promoted to the host node 320. The process is repeated as necessary until all nodes have been given the chance to be next node until all interested nodes are exhausted. An indication of completion of training is sent by the last node once there are no more nodes to run the training set. Another possible reason to stop the training process other than that all nodes that are interested are exhausted is if the model has reached a target performance requirement. For instance, if the model's target performance is to be able to classify cats with an accuracy of 80%, then if we trained it on 50% of the interested nodes and the indicated accuracy has been reached, then there is no reason to continue the training process. At that point, the last node holding the model would send an indication of training completion.

The completely trained model may then be sent to the nodes which have been part of the training process or to other modes in which the trained model is to be used elsewhere. If further nodes require to add training data anew, the process may be restarted by an appropriate indication to the last host.

In the configuration of FIG. 2 it is further noted each data node can communicate with every other node in the network. In this case, the computation of the next node is done locally within the node that currently hosts the model. This can be done in two ways. In the example shown above, T1 request samples of data from every other node to compute their FIM locally and decide on the next node, or it could send its own computed FIM value, the model and the FIM parameters to every other node and wait for each one to compute its local FD and send it back. Once received, T1 builds a distance matrix and chooses the next node according to a decision rule indicated by the objective of the model. The decision rule refers to the way the distance matrix is used to make the decision on the next node. For instance, the decision rule could be to choose the node that has the largest distance difference. In this case, the host node T1 would order the nodes based on their distances in an ascending manner and would choose the node that was ranked the highest. Another decision rule could be to choose the node with the closest distance. It also can be to choose the node that has the second closest distance, etc. depending on the training objectives.

It should be noted that the choice of the next node made based on the decision rule using the computed FDs depends on an objective indicated by the model owner. In addition, information relating to the current status of the model may also be used to define the decision rule. Other variables may also be used depending on the use case and other requirements of the model. The decision rule may define a target value of the comparative distance measure, such as the Fisher distance.

In one exemplary embodiment, the decision rules are assessed by Fisher distance being compared for each available node and then a preferred distance is selected based on the model objectives as described elsewhere herein. The objectives may be equated to a target value of Fisher distance which would satisfy the model objectives. The model objective can be considered to be a model parameter and to be based on data, status of the model, parameters or any other relevant model information. The target value of the Fisher distance is compared to each available node and that matching the required Fisher Distance measure is selected as the next node for training. If there is no exact match for the comparative distance measure from the nodes with the target value, the closest value to the target value is considered to be the matching value or the match to the target value. If there are multiple nodes that provide a matching distance the choice of next node is made on another target value based on another factor such as a weight or parameter associated with the node that has a relevance to the objective of the training requirements. In addition, if a node has already been a next node it may be excluded from comparison with the target value to determine the next node.

For example, if the model objective is to gain general knowledge, the decision of the next node is to choose the node with the furthest distance from the current node. This way, the model learns datasets that are diverse and hence will have a more holistic view and broader knowledge in the final training set. If the objective is to learn a specific set of features, then the choice is based on the closest next node in terms of distance. As expected, this would produce a narrower training data set. Hence, the decision rule is not fixed and is susceptible to change from one model to the next and from one dataset distribution to the other.

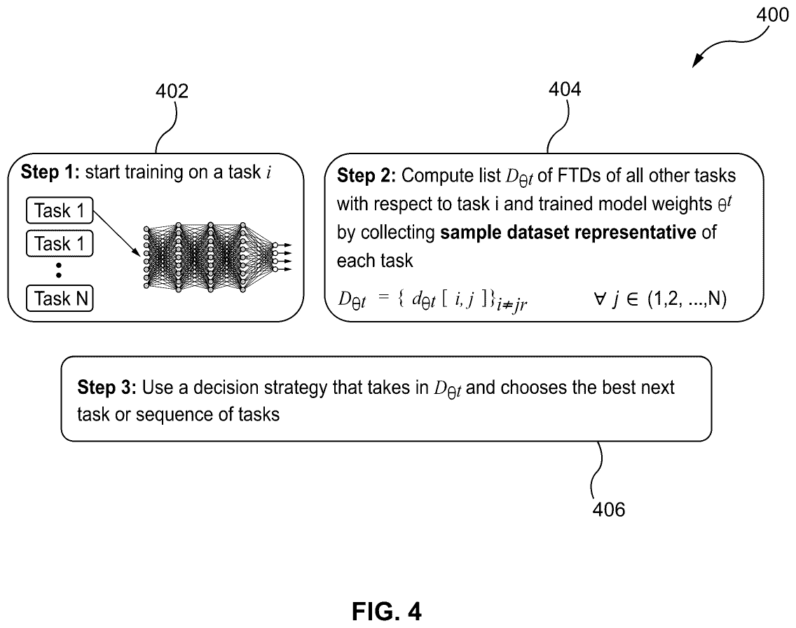

FIG. 4 shows an example of the main steps 400 of the above-described process of training the model for multiple data sets for respective nodes or tasks. Step 1 402 comprises start training on a task i. Step 1 shows a representation of an artificial neural network (ANN) which is shown in greater detail in FIG. 6. This is the model being trained on the tasks represented by the nodes. Step 2 404 comprises compute list D_{θ}_{^{t}} of Fisher Task Distances of all other tasks with respect to task i and trained model weights et by collecting sample dataset representative of each Task other than the first task. Where:

$${D}_{{θ}^{t}} = {\{ {d}_{{θ}^{t}} [ i , j ] \}}_{i \neq j} , ∀ j ∈ ( 1 , 2 , … , N ) \qquad equation 2$$

where D represents the matrix/vector of FDs, while dₑ_{^{t}} [i, j] represents the distance between task i (which was task T_a in equation 1) and task j (which was Task T_n in equation 1) where j could be any task other than task i.

Step 3 406 comprises using a decision rule or strategy that takes in D_{θ}_{^{t}} and chooses the best next task or sequence of tasks. As stated above the manner in which the rule or strategy for the decision is determined based on use case and any relevant variable in the model, its uses, its type and its content. As described above the decision rule may be based on the target value of the Fisher distance.

The proposed method can be used in many applications including but not limited to autonomous driving, satellites processing and Internet of the thing (IoT). Essentially the method is relevant to any setting where, for example, data privacy is important, and communication resources are limited.

The method is used in the context of sequential and continual learning where data is distributed among different nodes that are able to communicate together. The method may also find some utility in other distributed learning methods such as knowledge distillation where the teacher and student pairing choice can be made, federated learning where the nodes to participate could be carefully chosen, etc. As a result, different scenarios are presented in FIGS. 2, 5 and 6.

FIG. 5 shows a centralised configuration 500 in which nodes T1, T2, T3, T4, T5 and T6 are connected to a central node labelled “sequencer” 502. The sequencer 502 is located in the middle of all the data nodes T1, T2, T3, T4, T5 and T6 and handles the choice of the next node. In FIG. 5 the first node mentioned above is T1 and this is the node that currently holds the model. In this example instead of the first node sending the locally trained copy of the model 202 to the sequencer 502 along with the local FIM value and the FIM parameters used to compute the FIM, the sequencer 502 requests data samples from each of the other nodes to compute their FIMs using the copy of the received model 202. Then, according to the next node rule determined by the model training objective, the sequencer chooses the next node.

In alternative embodiments, the sequencer 502 can also function in an opposite manner. It can first receive the model and the FIM value and FIM parameters from T1 (for example), distribute a copy of the model to all other nodes along with the FIM parameters and FIM value as indicated by T1. The sequencer then collects the FD of each node and decides on the next node. The main difference between this setup and the described in the foregoing is the fact that in the previous setup each node has a direct link to every other node. However, here, each node only sees the sequencer. In the first one, a node that holds the model is known to everyone else, but here, only the sequencer knows where the model is.

FIG. 6 shows a further example of a network of nodes 600 according to the present technology. In this example, there are clusters of data nodes that might be logically or physically separated. Each data node in a cluster have intra-cluster links over which Fisher information, parameters, and model can be exchanged. Intra-cluster links are links that refer to communications between nodes within a given cluster. Nodes within a cluster are configured in, for example, a centralized setup where there is a sequencer unit to which the nodes could be connected in a star like formation (cluster H). The network may alternatively or additionally include one or more nodes clustered in a decentralized fashion (for example clusters T and G). Each cluster may itself be operating in a hierarchal setup like the one being described here. In this example shown above, cluster N is another hierarchical cluster.

In addition to intra-link communications, there are inter-cluster links that connect individual clusters together. A cluster might have one or more inter-cluster links. For instance, in the FIG. 6 example, cluster N has a single inter-cluster link that connects it to one of the nodes H6 in the centralized cluster. In one example, within each cluster, and depending on the internal setup, one or more nodes can be chosen to be the cluster head/s or cluster representative/s to which the inter-cluster links are connected. In Cluster T, node T1 is the only cluster head chosen and it has two inter-cluster links, one to Cluster H and one to Cluster G. In cluster G two nodes G1 and G2 chosen as cluster heads, wherein node G2 connects to cluster M and node G1 has two inter-cluster links, one to cluster H and the other to cluster T.

Additionally, in the case of centralized setup for intra-cluster communication, as in cluster H, the sequencer could act as a cluster head for example. However, any of the other nodes could also take that role. For instance, in cluster H, node H6 and the sequencer may both act as cluster heads, wherein the sequencer has inter-cluster links to clusters T and N, while node H6 connects to clusters H and N.

The role of the cluster head is to act as the point of contact between the individual clusters. It is responsible for sharing model, local FIM, FIM parameters, or any information required by other clusters to make model mobility decisions. This inter-cluster information is used to decide to move the model between clusters. However, once the model is at a cluster, where it goes in the cluster (i.e., to which node within the cluster) for training, is only visible to the nodes within the cluster. Other clusters do not know any additional details about each other except that exposed through the cluster heads.

In the example shown in FIG. 6, the current model is held by node H1 in cluster H. After completing the training, the sequencer collects the required information from its own cluster nodes, as well as information exposed by the cluster heads of the other clusters. Accordingly, the sequencer or other cluster head computes that the best next node is in cluster T which has distance score of X. The sequencer does not know which exact node within cluster T scored distance X, so the sequencer sends the model to node T1 which is the cluster head of cluster T indicating that the next node should be the one associated with score X and is found in cluster T. Node T1 then resolves which node has score X and sends the model to which (in this example, that node is T5).

A variety of different arrangements of clusters can occur along with numerous variations in the nature of each cluster and the nodes therein. Whatever the circumstances the process remains in line with the steps of FIG. 3 or 4 with a next node being sought by the current first or host node based on the determined Fisher distance of the nodes that contain data to be trained by the model.

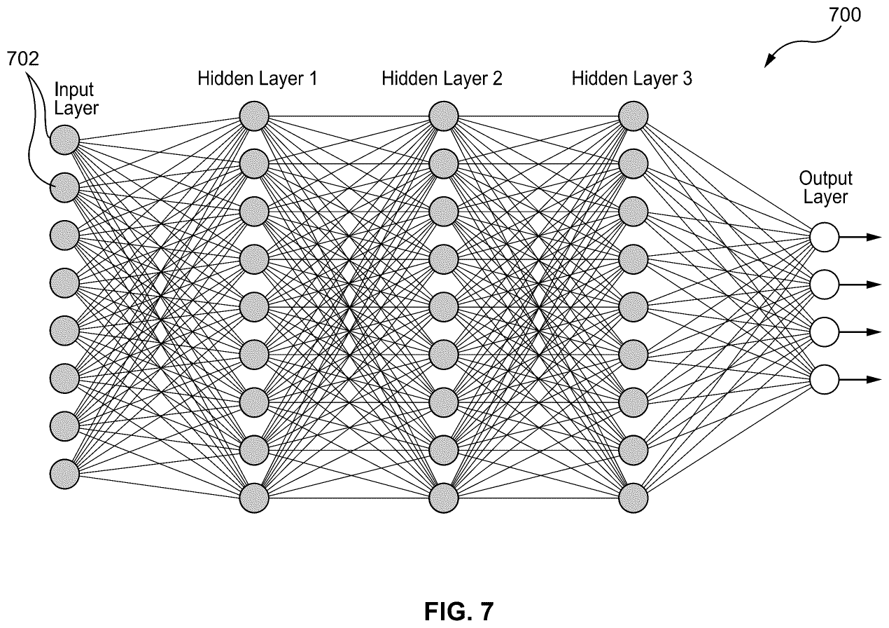

The model being trained by the training data may comprise a multilayer model such as an artificial neural network (ANN). For convenience a blown up version of the model shown in FIG. 3 is represented and further described with reference to FIG. 7. The ANN 700 comprises a number of layers including an input layer; hidden layers (three are shown); and an output layer. Each layer is composed of nodes 702 (neurons) that are interconnected. The layers work together to process data through a series of transformations. The input layer is where the data from the nodes enters the model. Each input is representative of a data value in the data set. The hidden layers carry out the computational steps of the model and the output layer provides output predictions which may comprise a classification for a categorical model and is numerical for a regression model. Training is an iterative process that uses a sequence of one or more functions with learnable parameters from layers that have transformed data into interpretable features or used those features to classify the input data set.

It will be appreciated that different models, training data and networks may be envisaged.

The trained and personalized model provided by the systems and methods described herein may be stored on memory of a device of the user, or stored on memory of a server that can be accessed by the device. Exemplary software applications include:
Assistive Technology: Helping individuals with disabilities interact with computers using eye movements.
User Experience Research: Analyzing where users look on a screen or in a physical environment to improve product design and marketing strategies.
Automotive: Monitoring drivers' for signs of distraction or drowsiness to enhance road safety.
Gaming and VR: Creating more immersive and interactive gaming experiences.
Psychology and Neuroscience: Studying attention, cognition, and social interaction through analysis.
Retail: Understanding customer behavior and preferences in stores.
Medical Diagnostics: Assisting in diagnosing conditions like autism or concussions.

Systems and methods described herein utilize a new distance measure to choose a next data node for training a model in a continual learning process. In embodiments, Fisher Information is used to decide on a sequence of tasks in continual learning setting using sample datasets from the tasks to be learned and a light weight compute operation of the Fisher distance.

Systems and methods support privacy as the method requires nodes to compute their own FIM locally using a copy of the model such that no data is exposed to other nodes. In another setting, where a central hub node is acting as the sequencer, the privacy is still maintained.

Systems and method described herein improve the performance of typical anti-catastrophic forgetting methods. Extensive experiments were conducted in which the proposed method was coupled with typical continual learning methods and the results have showed considerable improvements under this coupling. The improvements came in the form of improvement in the overall final accuracy, as well as speed of convergence.

Systems and methods described herein are efficient in that data nodes are responsible for computing their local FIM only which is a light weight process. One copy of the model needs to be communicated between nodes and in response N−1 FIM values are shared back which makes this method communication efficient.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of training a model on datasets from a plurality of nodes in a network, the method performed by one or more computer processors executing software instructions, the method comprising:
identifying a first host node in the network that is currently hosting the model to train the model according to a first data set associated with the first node;
determining a comparative distance measure from each node in the network that is available for hosting training to becoming a next host node; and
identifying the next host node in the network based on a decision rule that evaluates the comparative distance measure for each available node.

2. The method of claim 1, wherein the comparative distance measure comprises a Fisher distance.

3. The method of claim 2, further comprising sending a trigger for available nodes to indicate a state to be considered as the next host node.

4. The method of claim 3, further requesting each available node configured to provide a Fisher distance based on a Fisher information matrix (FIM).

5. The method of claim 4, wherein the Fisher distance is calculated based on the following equation:
$${D}_{{θ}^{t}} = {\{ {d}_{{θ}^{t}} [ i , j ] \}}_{i \neq j} , ∀ j ∈ ( 1 , 2 , … , N )$$
where: D_{θ}_{^{t}} is a vector containing a set of fisher distances between the i^{th} dataset and the j^{th} dataset with respect to model weights at time t given by θ^{t} θ^{t} corresponds to the model weights after training on the dataset associated with the current host node.

6. The method of claim 2, wherein the decision rule is based on the Fisher Distance.

7. The method of claim 2, wherein the decision rule is based on comparing the Fisher Distance with a target value indicative of a model parameter.

8. The method of claim 1, wherein the decision rule selects as the next node a node with one of: a furthest distance from the first host node or a closest distance to the first host node.

9. The method of claim 1, comprising one of the plurality of nodes acting as a computing surrogate node for another one of the plurality of nodes, the computing surrogate node receiving a minibatch of data from the dataset of the another node and determining the comparative distance measure on behalf of the another node using the model based on the minibatch.

10. The method of claim 1, comprising a central sequencer receiving the model from the host node and a minibatch of data from the dataset of each of the plurality of nodes and determining the comparative distance measure for each of the nodes using the model based on the minibatch.

11. The method of claim 1, comprising a central sequencer receiving the comparative distance measure determined at each of the nodes, the central sequencer identifying the next host node based on the received comparative distance measures.

12. The method of claim 1, wherein the comparative distance measure is determined using the model and a minibatch or sample of the dataset of each of the nodes.

13. The method of claim 1, wherein the comparative distance measure represents a distance in parameter space between the model as trained by the dataset of the host node and the model as trained by a sample of the dataset of each of the plurality of nodes.

14. The method of claim 1, wherein the network is one or more of: decentralized, centralized, fully connected and hierarchical.

15. The method of claim 1, wherein the model comprises a neural network.

16. The method of claim 1, wherein the network comprises multiple networks each comprising one or more nodes to be trained.

17. The method of claim 1, wherein the network comprises multiple networks, each of the multiple networks comprising a cluster of nodes, wherein the comparative distance measure is communicated from a designated head node of each of the clusters of nodes without communicating the datasets or a part thereof between the clusters of nodes.

18. A method of training an Artificial Intelligence (AI) model on datasets from a plurality of nodes connected to form a knowledge sharing network, the method performed by at least one computer processor executing programming instructions, the method comprising:
identifying a first host node in the knowledge sharing network that is currently hosting the AI model to train the model according to a first data set associated with the first host node;
determining a comparative distance measure between the first dataset associated with the first host node and each dataset associated with each node in the knowledge sharing network that is available for hosting and continue training the AI model to becoming a next host node;
identifying the next host node in the knowledge sharing network based on a decision rule that evaluates the comparative distance measures from each of the nodes available for hosting;
moving the AI model trained on the first host node towards the identified next host node to continue training the AI model according to a dataset associated with the identified next host node; and
stopping the next host node identification based on a set of predefined stoppage criteria.

19. The method of claim 18, wherein the stoppage criteria comprises at least one of a training target performance metric being achieved and the nodes available for hosting being exhausted.

20. A computer program product comprising instructions which, when the program is executed by a computer, cause the computer to carry out the steps of
identifying a first host node in a network that is currently hosting a model to train the model according to a first data set associated with the first node;
determining a comparative distance measure from each node in the network that is available for hosting training to becoming a next host node
identifying the next host node in the network based on a decision rule that evaluates the comparative distance measures for each node that is available for hosting training.
